(19) United States
(12) Patent Application Publication
(10) Pub. No.: US 2013/0166310 A1
(43) Pub. Date: Jun. 27, 2013

(54) METHODS AND APPARATUS RELATED TO SOCIAL BENEFIT DETERMINATIONS

(71) Applicants: Mirko Schnack, Mannheim (DE); Lutz Garstecki, Muehlhausen (DE); Miroslav Cina, Hanhofen (DE); Claus Steimer, Weingarten (DE); Erik Dworog, Heidelberg (DE)

(72) Inventors: Mirko Schnack, Mannheim (DE); Lutz Garstecki, Muehlhausen (DE); Miroslav Cina, Hanhofen (DE); Claus Steimer, Weingarten (DE); Erik Dworog, Heidelberg (DE)

(73) Assignee: SAP AG, Walldorf (DE)

(21) Appl. No.: 13/336,896

(22) Filed: Dec. 23, 2011

(51) Int. Cl. G06Q 10/00

(52) U.S. Cl. 705/1.1

(57) ABSTRACT

In one general aspect, a computer system can include an input data parser configured to receive a plurality of input values from an application for a social benefit, and a first phase module configured to determine a first result based on a first phase of benefit decision processing using a first input value from the plurality of input values, and configured to trigger processing associated with a second phase of benefit decision processing based on the first input value from the plurality of input values satisfying a phase triggering condition. The computer system can include a second phase module configured to receive the first result from the first phase module, and configured to determine a second result based on the second phase of benefit decision processing using the first result and a second input value from the plurality of input values.

### TECHNICAL FIELD

This description relates to social benefit determinations.

### BACKGROUND

Many known techniques exist for determining a social benefit for an applicant based on policies related to the social benefit. Making a determination related to a social benefit using known techniques, however, can be time-consuming and/or computationally expensive because of the number and complexity of policies that can be applied. For example, in some instances, policies related to a social benefit can be needlessly applied to a particular applicant who may not meet threshold criteria related to the social benefit. In addition, adjustments to a benefit decision may not be processed in a desirable fashion using known processing techniques. Thus, a need exists for systems, methods, and apparatus to address the shortfalls of present technology and to provide other new and innovative features.

### SUMMARY

In one general aspect, a computer system can include instructions stored on a non-transitory computer-readable storage medium. The computer system can include an input data parser configured to receive a plurality of input values from an application for a social benefit, and a first phase module configured to determine a first result based on a first phase of benefit decision processing using a first input value from the plurality of input values, and configured to trigger processing associated with a second phase of benefit decision processing based on the first input value from the plurality of input values satisfying a phase triggering condition. The computer system can include a second phase module configured to receive the first result from the first phase module, and configured to determine a second result based on the second phase of benefit decision processing using the first result and a second input value from the plurality of input values. The computer system can include an update module configured to receive an indicator of the first input value being changed to an updated input value, and configured to trigger, in response to the indicator of the change, re-processing of at least a portion of the application based on the first phase of benefit decision processing using the updated input value.

In another general aspect, a non-transitory computer-readable storage medium can store code representing instructions that when executed are configured to cause a processor to perform a process. The code can include code to receive a plurality of input values from an application for a social benefit, and to determine a first result based on a first phase of benefit decision processing using a first input value from the plurality of input values. The code can include code to trigger processing associated with a second phase of benefit decision processing based on the first input value from the plurality of input values satisfying a phase triggering condition and code to determine a second result based on the second phase of benefit decision processing using the first result and a second input value from the plurality of input values. The code can include code to receive an indicator of the first input value being changed to an updated input value, and to trigger, in response to the indicator of the change, re-processing of at least a portion of the application based on the first phase of benefit decision processing using the updated input value.

In yet another general aspect, a method can include executing instructions recorded on a non-transitory computer-readable storage media using at least one processor. The method can include receiving a plurality of input values from an application for a social benefit, and determining a first result based on a first phase of benefit decision processing using a first input value from the plurality of input values. The method can include triggering processing associated with a second phase of benefit decision processing based on the first input value from the plurality of input values satisfying a phase triggering condition and can include determining a second result based on the second phase of benefit decision processing using the first result and a second input value from the plurality of input values. The method can also include receiving an indicator of the first input value being changed to an updated input value, and can include triggering, in response to the indicator of the change, re-processing of at least a portion of the application based on the first phase of benefit decision processing using the updated input value.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram that illustrates a benefit module, according to an embodiment.

FIG. 2 is a diagram that illustrates an embodiment of benefit decision processing.

FIG. 3 is a flowchart that illustrates a method for benefit decision processing, according to an embodiment.

FIG. 4 is a diagram that illustrates an example of benefit rules, according to an embodiment.

FIG. 5 is a diagram that illustrates a specific example of benefit decision processing including an eligibility phase and an entitlement phase, according to an embodiment.

### DETAILED DESCRIPTION

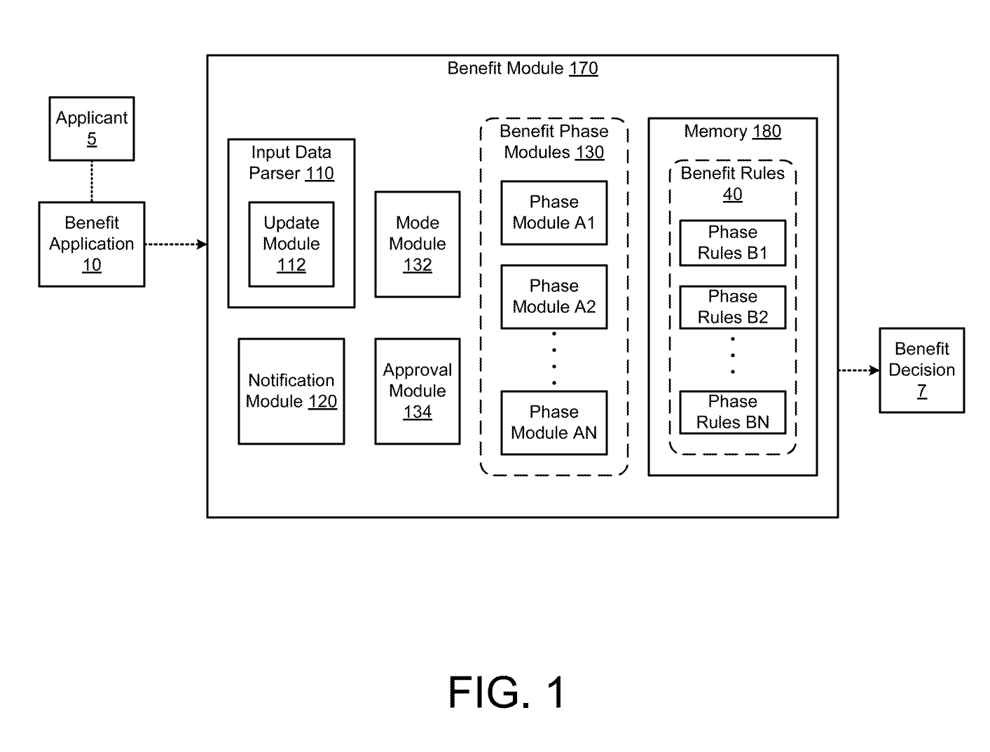

FIG. 1 is a block diagram that illustrates a benefit module 170, according to an embodiment. The benefit module 170 is configured to handle benefit decisions for one or more individuals related to various types of benefits (also can be referred to as social benefits) administered by entities such as a government (e.g., local government, state government, federal government) organizations, businesses, social program administrators, and/or so forth through one or more social benefit programs. Individuals applying for a particular benefit can be referred to as applicants, and entities administering benefits, for which an applicant can apply, can be referred to as benefit administration entities. In some embodiments, the benefits can include, for example, pension benefits, unemployment benefits, maternity leave benefits, social service benefits, tax benefits, insurance benefits food benefits, legal benefits, family service benefits, medical benefits, and/or so forth.

As shown in FIG. 1, the benefit module 170 is configured to receive a benefit application 10 associated with an applicant 5. The benefit module 170 is configured to perform processing related to one or more benefit decisions for the applicant 5 based on one or more input values included in the benefit application 10. In some embodiments, processing performed by the benefit module 170 can be performed in response to one or more input values included in the benefit application 10 being received at the benefit module 170. Input values included in the benefit application 10 can be processed by (e.g., retrieved by, parsed by) an input data parser 110 of the benefit module 170. In some embodiments, the benefit application 10 can be sent to the benefit module 170 from a computing device (not shown) via a network (not shown).

In some embodiments, the input value(s) included in the benefit application 10 can be produced by (e.g., entered by, manually entered by) the applicant 5 using, for example, a paper medium, a voice-activated tool, an agent, an electronic user-interface associated with a web-page or software program, and/or so forth. In some embodiments, the input value(s) included in the benefit application 10 can include any type of information that can be used to make a determination related to a benefit. For example, one or more of the input values of the benefit application 10 can include personal information related to and/or characteristics (e.g., attributes) of the applicant 5 (e.g., name, age, gender, residence address, marital status, etc.), an identification of the benefit to which the benefit application 10 is related, benefit options or preferences selected by the applicant 5, medical information (e.g., medical history) of the applicant 5, preferences of the applicant 5, and/or so forth.

One or more input values included in the benefit application 10 can be used by the benefit module 170 to determine (e.g., define, calculate, produce, generate) a benefit decision 7. In some embodiments, the benefit decision 7 can be, or can include, one or more parameters defining a benefit to which the applicant 5 is entitled within one or more benefit programs. As a specific example, the benefit decision 7 can indicate that the applicant 5 is, or is not, entitled to a specific pension benefit within a specified period of time related to a pension program. In some embodiments, the benefit decision 7 can be referred to as a benefit result or as a final benefit decision.

As shown in FIG. 1, the benefit module 170 includes benefit phase modules 130, which include phase modules A1 through AN. The benefit phase modules 130 are configured to perform processing related to the benefit decision in phases (e.g., distinct phases, distinct time periods (e.g., timeframes), eligibility phases, entitlement phases) based on phase rules B1 through BN. In this embodiment, phase modules A1 through AN correspond, based on the indices 1 through N, with the phase rules B1 through BN. In some embodiments, the phase rules B1 through BN can collectively define, or can be referred to as benefit rules 40. Each of the phase rules from the phase rules B1 through BN can include one or more rules. In some embodiments, processing related to a benefit decision can be referred to as benefit decision processing. In some embodiments, the phases can be referred to as stages or as phases of processing (e.g., processing phases).

For example, the phase module A1 can be configured to perform a first phase of processing related to a benefit decision based on phase rules B1. After the first phase of processing related to the benefit decision performed by the phase module A1 based on phase rules B1 has been completed, a second phase of processing related to the benefit decision based on phase rules B2 can be performed by phase module A2. In some embodiments, one or more of the benefit phase modules 130 (or processing performed thereby) can be associated with a particular caseworker or department within a benefit administration entity.

In some embodiments, a first phase module from the benefit phase modules 130 can be related to an eligibility portion of a benefit decision and a second phase module from the benefit phase modules 130 can be related to an entitlement portion of the benefit decision. For example, in some embodiments, the phase module A1 can be configured to perform processing related to an eligibility portion of a benefit decision, and the phase module A2 can be configured to perform processing related to an entitlement portion of the benefit decision. In such embodiments, the phase rules B1 (used by the phase module A1) can be referred to as eligibility rules, and the phase rules B2 (used by the phase module A2) can be referred to as entitlement rules. In some embodiments, the eligibility portion of the benefit decision can be related to an overall eligibility to a benefit program and the entitlement portion of the benefit decision can be related to specific (or more granular) entitlements within the benefit program.

Each of the benefit phase modules 130 can be configured to determine (e.g., calculate, generate, produce) one or more results associated with benefit decision processing to determine the benefit decision 7. In some embodiments, the results can be intermediate results that are used to determine the benefit decision 7. In some embodiments, intermediate results can be processed between various portions of the benefit phase modules 130.

For example, a first result (which can be referred to as a first intermediate result) can be sent from one portion of the benefit phase modules 130 to another portion of the benefit phase modules 130 for further benefit decision processing. As a specific example, in some embodiments, a first result determined by a first portion of the benefit phase modules 130 can be sent to and processed at a second portion of the benefit phase modules 130. The first result can identify portion of a benefit available to the applicant 5. The second portion of the benefit phase modules 130 can be configured to determine a second result (which can be referred to as a second intermediate result) based on the first result. The second result can be a more specific identification of the benefit available to the applicant 5. In some embodiments, one or more results (e.g., intermediate results) determined by one or more of the benefit phase modules 130 can be designated as, or included in, at least a portion of the benefit decision 7.

In some embodiments, one or more results determined by one or more of the benefit phase modules 130 can be based on one or more input values associated with the benefit application 10. In some embodiments, the one or more input values can be initially processed by (e.g., received by) the input data parser 110 from the benefit application 10 and can be provided to the benefit phase modules 130 for further processing.

For example, phase module A1 can be configured to receive one or more input values from the benefit application 10 (via the input data parser 110), and can be configured to determine a result (e.g., a benefit decision, parameters associated with a benefit decision) based on the input value(s). As a specific example, phase module A1 can be configured to determine that the applicant 5 may be eligible for a particular benefit (which can be an intermediate result) based on the residence address of the applicant 5 (which can be an input value from the benefit application 10).

In some embodiments, a result (e.g., an intermediate result, a final benefit decision) determined by one of the benefit phase modules 130 can be based on a combination of input values and another result (e.g., another intermediate result). For example, phase module A1 can be configured to receive a first input value from the benefit application 10, and can be configured to determine a first result (e.g., a benefit decision, parameters associated with a benefit decision) based on the first input value. Phase module A2 can be configured to determine a second result based on a combination of a second input value from (e.g., retrieved from) the benefit application 10 and the first result determined by the phase module A1.

As a specific example, a zip code of a residence of the application 5 (which can be a first input value) can be retrieved from the benefit application 10 as an input value and can be processed at the phase module A1 to determine that the applicant 5 is eligible for a benefit during a time period (e.g., timeframe) (which can be a first result). The time period during which the applicant 5 is eligible for the benefit can be provided to (e.g., sent to) the phase module A2 and can be used by the phase module A2 along with age information (which can be a second input value) to determine a maximum monetary benefit (which can be a second result) for which the applicant 5 is eligible during the time period.

The benefit rules 40 (or portions thereof) can include one or more phase triggering conditions. When one or more of the phase triggering conditions are satisfied (or unsatisfied), processing associated with one or more phases of a benefit decision by one or more of the benefit phase modules 130 can be triggered. When one or more of the phase triggering conditions is not satisfied (e.g., is unsatisfied) (or satisfied), processing associated with one or more phases of a benefit decision by one or more of the benefit phase modules 130 can be terminated. In other words, satisfying (or not satisfying) of one or more phase triggering conditions can function as a pre-requisite for further processing by one or more of the benefit phase modules 130. In some embodiments, a phase triggering condition can be satisfied, or unsatisfied, based on a result (e.g., an intermediate result) determined by (e.g., calculated by) one or more of the benefit phase modules 130, and/or based on an input value from the benefit application 10.

For example, the phase module A1 can be configured to perform processing related to a first phase of the benefit decision based on phase rules B1. The phase rules B1 can include a phase triggering condition, that when satisfied, can be configured to trigger processing of a second phase of the benefit decision performed by the phase module A2 based on phase rules B2 (or another of the phase modules based on at least a portion of the benefit rules 40). In some embodiments, in the event that the phase triggering condition remains unsatisfied, processing related to the benefit decision can be terminated (e.g., triggered for termination).

As a specific example, a phase triggering condition can be based on a residence address of an applicant being located within a municipality where a benefit is being administered by an administration entity. The phase triggering condition can be included in, or associated with, phase rules B1 and can be processed by the phase module A1. Benefit decision processing associated with the benefit can be terminated by the phase module A1 based on a first phase of processing in response to a residence address (which can be input values from the benefit application 10) of the applicant 5 being located outside of the municipality where the benefit is being administered.

In some embodiments, processing related to a benefit decision performed by the benefit phase modules 130 can be ordered (e.g., ordered in a series, ordered in a sequence). For example, processing related to a benefit decision performed by phase module A2 can be performed after (e.g., performed only after) processing related to the benefit decision performed by phase module A1 has been completed. Processing related to the benefit decision performed by phase module A3 can be performed after (e.g., performed only after) processing related to the benefit decision performed by phase module A2 has been completed.

In some embodiments, processing related to a benefit decision performed by a first portion of the benefit phase modules 130 can depend on processing performed by a second portion of the benefit phase modules 130. For example, depending on a result calculated via the processing performed by phase module A1, processing can be performed by phase module A2 or processing can be performed can be performed by phase module A3.

In some embodiments, benefit decision processing performed by the benefit phase modules 130 can be performed in a hierarchical fashion. In some embodiments, the hierarchical benefit decision processing can be based on a processing order (e.g., ordered sequence or series) of the benefit phase modules 130. For example, in some embodiments, if benefit decision processing is performed in order starting with phase module A1 and proceeding toward phase module AN, general and/or broad benefit decision processing can be performed by phase module A1 and more specific benefit decision processing can be performed by phase modules subsequent to phase module A1 (e.g., phase module A2, phase module AN).

In some embodiments, benefit decision processing performed by a first portion of the benefit phase modules 130 can be performed in parallel with benefit decision processing performed by a second portion of the benefit phase modules 130. In some embodiments, the benefit decision processing performed by the first portion of the benefit phase modules 130 can be related to the same benefit decision, or a different benefit decision as the benefit decision processing performed by the second portion of the benefit phase modules 130.

The benefit module 170 can be, or can be included within, for example, a client device and/or a server device. In some embodiments, the benefit module 170 can be, or can be included within, for example, a wired device and/or a wireless device (e.g., wi-fi enabled device) and can be, for example, a computing entity (e.g., a personal computing device), a mobile phone, a personal digital assistant (PDA) and/or so forth. The benefit module 170 can be configured to operate based on one or more platforms (e.g., one or more similar or different platforms) that can include one or more types of hardware, software, firmware, operating systems, runtime libraries, and/or so forth. In some embodiments, the benefit module 170 can be integrated with other benefit processing applications (e.g., programs).

In some embodiments, the memory 180 can be implemented as more than one memory component (e.g., more than one random-access memory (RAM) component or disk drive memory) within the benefit module 170. In some embodiments, the memory 180 can be, or can include, a non-local memory (e.g., a memory not physically included within the benefit module 170) within a network (not shown). For example, the memory 180 can be, or can include, a memory shared by multiple system upgrade modules (not shown) within a network.

Although not shown, the benefit module 170 can be configured to operate within an environment that includes an operating system. In some embodiments, the operating system can be configured to facilitate the functions of the benefit module 170.

In some embodiments, one or more portions of the components shown in the benefit module 170 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some embodiments, one or more portions of the benefit module 170 can be, or can include, a software module configured for execution by at least one processor and/or memory (not shown). In some embodiments, the functionality of the components can be included in different modules and/or components than those shown in FIG. 1.

In some embodiments, the benefit module 170 can be included within a network that can include multiple devices (e.g., multiple client devices, multiple server devices). For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can be have portions based on various protocols such as Internet Protocol (IP) and/or a proprietary protocol. The network can include at least a portion of the Internet. Also, although not shown in FIG. 1, the benefit module 170 can be configured to function within various types of network environments. In some embodiments, the benefit module 170 can represent, or can be included within, a cluster of modules/devices. In such an embodiment, the functionality and processing of the benefit module 170 can be distributed to several modules/devices of the cluster of modules/devices.

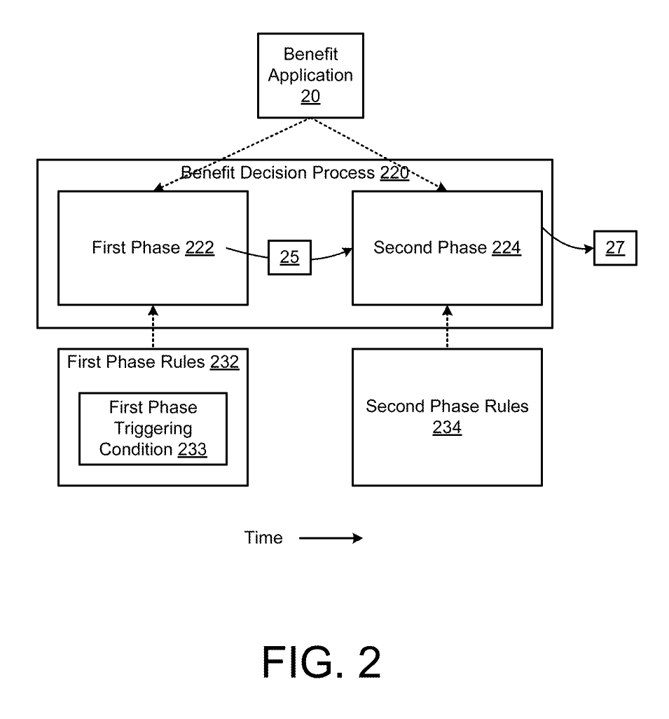

FIG. 2 is a diagram that illustrates an embodiment of benefit decision processing. In some embodiments, one or more portions of the benefit decision processing can be performed by the benefit module 170 shown in FIG. 1.

As shown in FIG. 2, based on a first phase 222 of a benefit decision process 220, input values from a benefit application 20 are processed based on first phase rules 232 including a first phase triggering condition 233. In this embodiment, in response to the first phase triggering condition 233 being satisfied, a result 25 (which can be an intermediate result) is produced during the first phase 222 of the benefit decision process 220 using the input values from benefit application 20 based on the first phase rules 232. In some embodiments, the first phase triggering condition 233 can be satisfied based on one or more of the input values from benefit application 20.

As shown in FIG. 2, based on a second phase 224 of the benefit decision process 220, second phase rules 234 are applied using input values from benefit application 20. In this embodiment, a result 27 (which can represent a final benefit decision or an intermediate result) is produced during the second phase 224 of the benefit decision process 220 based on the input values from benefit application 20 and based on the result 25. In some embodiments, input values from the benefit application 20 processed based on the first phase 222 can be different from input values from the benefit application 20 processed based on the second phase 224.

Although not shown, in some embodiments, the result 27 can be produced based on the input values from benefit application 20 alone (and not based on the result 25 from the first phase 222 of the benefit decision process 220. Although not shown, in some embodiments, the result 27 can be produced based on the result 25 from the first phase 222 of the benefit decision process 220 alone (and not based on input values from benefit application 20).

Referring back to FIG. 1, the benefit module 170 includes a mode module 132. The mode module 132 is configured to trigger the benefit module 170 (e.g., the benefit phase modules 130 of the benefit module 170) to operate in one of several modes. For example, the mode module 132 can be configured to trigger the benefit phase modules 130 (or a portion thereof) to operate in an automatic mode, a semi-automatic mode, and/or a manual mode. In some embodiments, a mode of operation of the benefit module 170 can be triggered by a user (e.g., an administrator, the caseworker) of the benefit module 170.

When operating in an automatic mode, benefit decision processing performed by the benefit module 170 (e.g., one or more of the benefit phase modules 130 of the benefit phase modules 130) can be automatically performed without intervention from, for example, a user (e.g., the caseworker). When operating in a semi-automatic mode, benefit decision processing performed by the benefit module 170 (e.g., one or more of the benefit phase modules 130 of the benefit phase modules 130) can be interrupted and/or can be contingent upon approval of, for example, a user (e.g., the caseworker). Input related to an approval can be requested (e.g., solicited) and/or received by an approval module 134 (via a user interface (not shown)). When operating in a manual mode, benefit decision processing performed by the benefit module 170 (e.g., one or more of the benefit phase modules 130 of the benefit modules 170) can be manually triggered by, for example, a user (e.g., the caseworker). In some embodiments, when operating in a manual mode, input values from benefit application 10 can be manually pushed (e.g., pushed by a caseworker) for processing by the benefit module 170.

When operating in a semi-automatic mode, benefit decision processing can be performed by a first phase module from the benefit phase modules 130, and further benefit decision processing by a second phase module from the benefit phase modules 130 may not be performed until a result produced by the first phase module has been approved (e.g., approved by a caseworker associated with a portion of (e.g., a department within) a benefit administration entity). For example, in some embodiments, while the benefit module 170 is operating in a semi-automatic mode, a first result determined by a first portion of the benefit phase modules 130 can be sent to and processed at a second portion of the benefit phase modules 130. The first result can identify portion of a benefit available to the applicant 5. The first result can be sent, via the approval module 134, to a user for approval. In response to the first result being approved (as received via the approval module 134), the second portion of the benefit phase modules 130 can be configured to determine a second result based on the first result. The second result can be a more specific identification of the benefit available to the applicant 5. Processing performed by the first portion of the benefit phase modules 130 can be associated with a different benefit administration entity (or portions (e.g., department) thereof) than the second portion of the benefit phase modules 130.

In some embodiments, modes of operation can be modified during processing performed by the benefit phase modules 130. For example, processing performed by phase modules A1 and A2 can be performed while in a semi-automatic mode, and processing performed by subsequent phase modules can be performed in an automatic mode (or vice versa). In some embodiments, the changing of the modes can be triggered by, for example, a user of the benefit module 170. In some embodiments, the benefit phase modules 130 can be configured so that portions of the benefit phase modules 130 can operate based on different modes (e.g., operate based on different modes by default).

As shown in FIG. 1, the input data parser 110 includes an update module 112. The update module 112 is configured to receive an indicator that one or more input values associated with the benefit application 10 have been updated. In some embodiments, the update module 112 can be configured to monitor the benefit application 10 to determine whether or not an update to one or more input values of the benefit application 10 have been entered, for example, by the applicant 5. As a specific example, an input value can be related to an expected date of birth of a child, and the input value can be updated to reflect an actual date of birth of the child. In some embodiments, an input value can be updated based on new data, a change in a medical condition of the applicant 5, an increase in pay of the applicant 5, relocation of the applicant 5, and/or so forth.

In response to an update to one or more of the input values associated with the benefit application 10 being updated, the update module 112 can be configured to trigger re-processing at the benefit module 170. For example, the update module 112 can be configured to trigger re-processing of the benefit application 10 (or a portion thereof) by one or more of the benefit phase modules 130. In other words, the update module 112 can be configured to trigger an additional or multiple iterations of benefit decision processing (associated with one or more applications) in response to an update (e.g., a changed input value, a new input value). In some embodiments, the update to the benefit application 10 can represent a changed circumstance of the applicant 5. In some embodiments, re-processing associated with the benefit application 10 can be triggered to correct for an error during a prior processing associated with the benefit application 10.

As a specific example, during a first iteration of benefit decision processing associated with the benefit application 10, phase module A1 can be configured to receive an input value from the benefit application 10 (via the input data parser 110), and can be configured to determine a first result (e.g., a benefit decision, parameters associated with a benefit decision) based on the first input value and based on the phase rules B1. In response to a phase triggering condition associated with the phase rules B1 being satisfied based on the input value, processing using phase module A2 can be triggered. Phase module A2 can be configured to receive the first result from the phase module A1, and can be configured to determine a second result based on the first result and based on the phase rules B2.

In response to receiving, at the update module 112, an indicator that the first input value has been changed, re-processing by the phase module A1 and the phase module A2 can be triggered during a second iteration of benefit decision processing associated with the benefit application 10. Specifically, during the second iteration of benefit decision processing associated with the benefit application 10, phase module A1 can be configured to receive the updated input value from the benefit application 10 (via the input data parser 110), and can be configured to determine a third result based on the updated input value and based on the phase rules B1. In response to a phase triggering condition associated with the phase rules B1 being satisfied based on the updated input value, processing using phase module A2 can be triggered. Phase module A2 can be configured to receive the third result from the phase module A1, and can be configured to determine a fourth result based on the third result and based on the phase rules B2.

Although in this embodiment, the phase triggering condition is satisfied during the first iteration and the second iteration of benefit decision processing, in some embodiments, the phase triggering condition may not be satisfied (e.g., may be unsatisfied) during the first iteration or the second iteration of benefit decision processing. In some embodiments, the third result can be the same as or different from the first result. In some embodiments, the fourth result can be the same as or different than the second result.

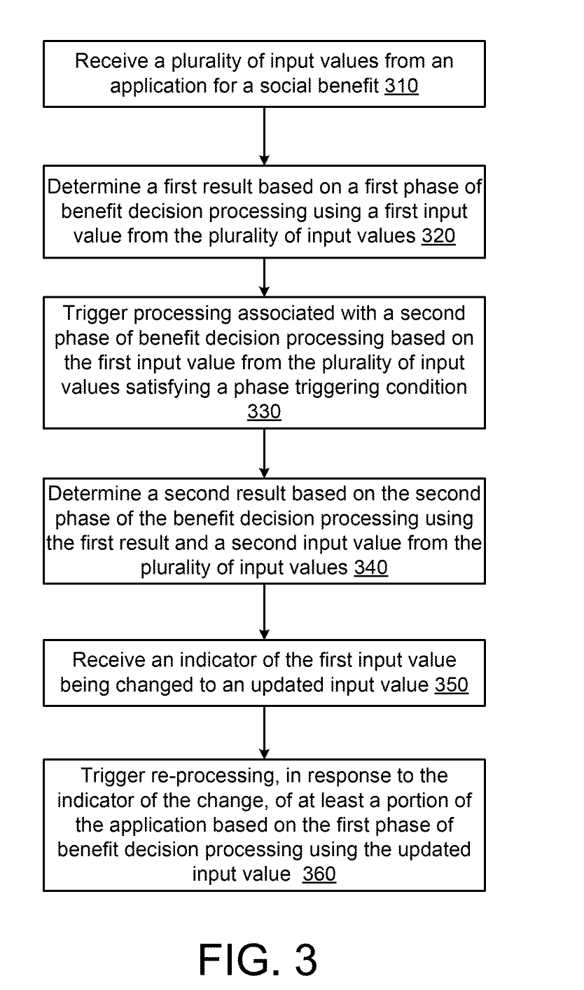

FIG. 3 is a flowchart that illustrates a method for benefit decision processing, according to an embodiment. In some embodiments, at least some portions of the flowchart can be performed by the benefit module 170 shown in FIG. 1.

A plurality of input values from an application for a social benefit is received (block 310). In some embodiments, the plurality of input values from the application for the social benefit can be received at the input data parser 110 shown in FIG. 1. In some embodiments, the application can be defined, at least in part, by an applicant for the social benefit. In some embodiments, the application can be electronically produced by the applicant.

A first result based on a first phase of benefit decision processing is determined using a first input value from the plurality of input values (block 320). In some embodiments, the first result can be determined based on the first phase of benefit decision processing by a phase module from the benefit phase modules 130 shown in FIG. 1.

Processing associated with a second phase of benefit decision processing based on the first input value from the plurality of input values satisfying a phase triggering condition is triggered (block 330). In some embodiments, the phase triggering condition can be included in at least one of the benefit rules 40 shown in FIG. 1.

A second result is determined based on the second phase of the benefit decision processing using the first result and a second input value from the plurality of input values (block 340). In some embodiments, the second result can be determined based on the second phase of benefit decision processing by a phase module from the benefit phase modules 130 shown in FIG. 1 (different from the phase module using in connection with block 320).

An indicator of the first input value being changed to an updated input value is received (block 350). In some embodiments, the indicator of the first input value being changed to the updated input value can be received by (and/or identified by) the update module 112 shown in FIG. 1.

Re-processing of at least a portion of the application is triggered, in response to the indicator of the change, based on the first phase of benefit decision processing using the updated input value (block 360). In some embodiments, the reprocessing can be triggered by the update module 112 shown in FIG. 1. Although not shown in FIG. 3, in some embodiments, the second phase of benefit decision processing can also be triggered by the update module 112 shown in FIG. 1. In some embodiments, multiple iterations of benefit decision processing including multiple phases can be triggered in response to changes of one or more portions of the application.

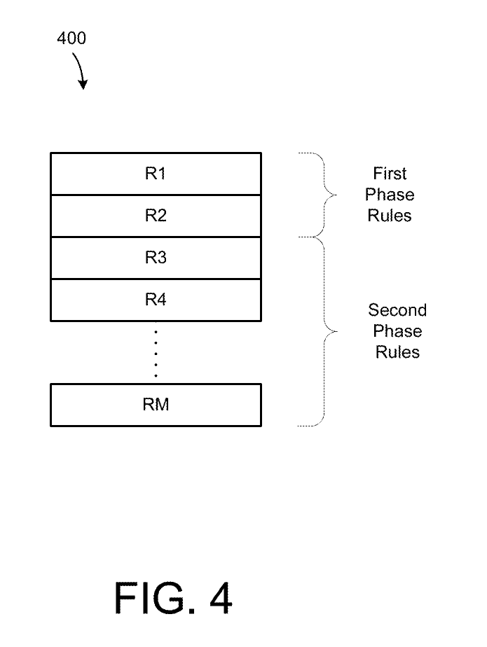

FIG. 4 is a diagram that illustrates an example of benefit rules 400, according to an embodiment. As shown in FIG. 4, the benefit rules 400 include benefit rules R1 through RM. As shown in FIG. 4, a portion of the benefit rules 400 are designated as first phase rules and another portion of the benefit rules 400 are designated as second phase rules. Specifically, benefit rules R1 and R2 are designated as first phase rules, and benefit rules R3 through RM are designated as the second phase rules. In some embodiments, the benefit rules 400 can be divided between phase rules in a manner different than that shown in FIG. 4.

In some embodiments, one or more of the benefit rules 400 can be, or can represent, a policy associated with one or more benefits. In other words, one or more of the benefit rules 400 can be, or can represent, rules associated with a benefit that can be applied using, for example, the benefit module 170 shown in FIG. 1 to make a benefit decision. Although not shown in FIG. 4, one or more of the benefit rules 400 can be associated with, or can include, a phase triggering condition.

Referring back to FIG. 1, in some embodiments, one or more portions of the benefit rules 40 can be updated (e.g., versioned, modified, amended, augmented, reduced). For example, phase rules B2 can be updated by, for example, a user of the benefit module 170.

In some embodiments, in response to one or more portions of the benefit rules 40 being updated, benefit decision processing (or re-processing) related to the benefit application 10 can be triggered. For example, during a first iteration of benefit decision processing associated with the benefit application 10, phase module A1 can be configured to receive an input value from the benefit application 10 (via the input data parser 110), and can be configured to determine a first result (e.g., a benefit decision, parameters associated with a benefit decision) based on the first input value and based on the phase rules B1. In response to a phase triggering condition associated with the phase rules B1 being satisfied based on the input value, processing using phase module A2 can be triggered. Phase module A2 can be configured to receive the first result from the phase module A1, and can be configured to determine a second result based on the first result and based on the phase rules B2. In response to phase rules B1 and/or phase rules B2 being updated, re-processing by the phase module A1 and/or the phase module A2 of the benefit application 10 can be triggered (e.g., triggered during a second iteration).

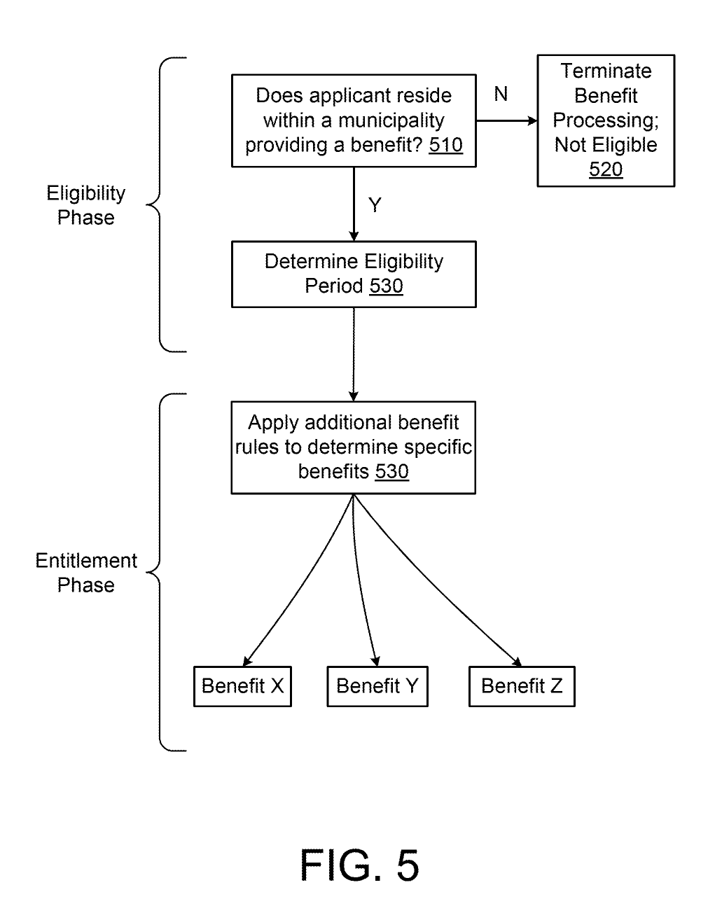

FIG. 5 is a diagram that illustrates a specific example of benefit decision processing including an eligibility phase and an entitlement phase, according to an embodiment. As shown in FIG. 5, a determination is made as to whether an applicant resides within a municipality providing a benefit (block 510). In this embodiment, the query included in block 510 can be a phase triggering condition that, when unsatisfied (e.g., determined in the negative), can result in the termination of benefit processing and a determination that the applicant is not eligible (i.e., ineligible) for the benefit (block 520).

In response to the query included in block 510 being satisfied (e.g., determined in the positive) an eligibility period can be determined (block 530). In some embodiments, the eligibility can be a time period during which an applicant may be eligible for the benefit. An indicator of the eligibility period can be sent from the eligibility phase of benefit processing to the entitlement phase of benefit processing.

As shown in FIG. 5, additional benefit rules are applied to determine specific benefits within the eligibility period. In this embodiment, the specific benefits within the eligibility period are illustrated as benefit X, benefit Y, and benefit Z. In some embodiments, the specific benefits can be, for example, an amount of a monetary benefit, a more specific time period for eligibility for a benefit within the eligibility period, a limitation on a benefit, an eligibility condition, an indicator of granting or denial of certain benefit, and/or so forth.

Implementations of the various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium can be configured to store instructions that when executed cause a processor to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry (e.g., an FPGA (field programmable gate array) or an ASIC (application-specific integrated circuit)).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data (e.g., magnetic, magneto-optical disks, or optical disks). Information carriers suitable for embodying computer program instructions and data include all forms of non-volatile memory, including by way of example semiconductor memory devices (e.g., EPROM, EEPROM, and flash memory devices); magnetic disks (e.g., internal hard disks or removable disks); magneto-optical disks; and CD-ROM and DVD-ROM disks. The processor and the memory may be supplemented by, or incorporated in special purpose logic circuitry.

To provide for interaction with a user, implementations may be implemented on a computer having a display device (e.g., a cathode ray tube (CRT), a light emitting diode (LED), or liquid crystal display (LCD) display device) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

Implementations may be implemented in a computing system that includes a back-end component (e.g., as a data server), or that includes a middleware component (e.g., an application server), or that includes a front-end component (e.g., a client computer having a graphical user interface or a Web browser) through which a user can interact with an implementation, or any combination of such back-end, middleware, or front-end components. Components may be interconnected by any form or medium of digital data communication (e.g., a communication network). Examples of communication networks include a local area network (LAN) and a wide area network (WAN) (e.g., the Internet).

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A computer system including instructions stored on a non-transitory computer-readable storage medium, the computer system comprising:
an input data parser configured to receive a plurality of input values from an application for a social benefit;
a first phase module configured to determine a first result based on a first phase of benefit decision processing using a first input value from the plurality of input values, and configured to trigger processing associated with a second phase of benefit decision processing based on the first input value from the plurality of input values satisfying a phase triggering condition;
a second phase module configured to receive the first result from the first phase module, and configured to determine a second result based on the second phase of benefit decision processing using the first result and a second input value from the plurality of input values; and
an update module configured to receive an indicator of the first input value being changed to an updated input value, and configured to trigger, in response to the indicator of the change, re-processing of at least a portion of the application based on the first phase of benefit decision processing using the updated input value.

2. The computer system of claim 1, wherein the first phase of benefit processing and the second phase of benefit processing define at least a portion of an ordered series of phases of the benefit processing.

3. The computer system of claim 1, wherein satisfying the phase triggering condition is a prerequisite to triggering processing associated with the second phase of the benefit decision processing.

4. The computer system of claim 1, further comprising:
an update module configured to trigger iterative processing related to the application for the social benefit based on the first phase and the second phase of the benefit decision processing.

5. The computer system of claim 1, wherein the first result is an eligibility time period, the determining the second result includes selecting a portion of the eligibility time period.

6. The computer system of claim 1, receive an indicator of a change in a mode related to the benefit decision processing from an automatic mode to a semiautomatic mode after the first input value is changed to the updated input value.

7. The computer system of claim 1, receive, before determining the first result, an indicator that a mode for the benefit decision processing is a semi-automatic mode,
the computer system, further comprising:
an approval module configured to send the first result to the second phase module after approval related to the first result is received.

8. The computer system of claim 1, wherein at least one of the first phase module or the second phase module is configured to operate in an automatic mode or a semi-automatic mode.

9. The computer system of claim 1, wherein the first result is an intermediate result and the second result is a benefit decision.

10. The computer system of claim 1, wherein the social benefit includes at least one of a medical benefit or a pension benefit.

11. The computer system of claim 1, wherein the application is a first application,
receive a plurality of input values from a second application for the social benefit; and
terminate processing related to the second application in response to the phase triggering condition being unsatisfied based on an input value from the plurality of input values from the second application.

12. The computer system of claim 1, wherein the phase triggering condition includes a single inquiry related to at least one of an age, a location, a gender, or a citizenship.

13. The computer system of claim 1, wherein the first phase of the benefit decision processing is eligibility phase processing, and the second phase of the benefit decision processing is entitlement phase processing.

14. A non-transitory computer-readable storage medium storing code representing instructions that when executed are configured to cause a processor to perform a process, the code comprising code to:
receive a plurality of input values from an application for a social benefit;
determine a first result based on a first phase of benefit decision processing using a first input value from the plurality of input values;
trigger processing associated with a second phase of benefit decision processing based on the first input value from the plurality of input values satisfying a phase triggering condition;
determine a second result based on the second phase of benefit decision processing using the first result and a second input value from the plurality of input values;
receive an indicator of the first input value being changed to an updated input value; and
trigger, in response to the indicator of the change, re-processing of at least a portion of the application based on the first phase of benefit decision processing using the updated input value.

15. The non-transitory computer-readable storage medium of claim 14, wherein the first phase of benefit processing and the second phase of benefit processing define at least a portion of an ordered series of phases of the benefit processing.

16. The non-transitory computer-readable storage medium of claim 14, wherein satisfying the phase triggering condition is a prerequisite to triggering processing associated with the second phase of the benefit decision processing.

17. A method including executing instructions recorded on a non-transitory computer-readable storage media using at least one processor, the method comprising:
receiving a plurality of input values from an application for a social benefit;
determining a first result based on a first phase of benefit decision processing using a first input value from the plurality of input values;
triggering processing associated with a second phase of benefit decision processing based on the first input value from the plurality of input values satisfying a phase triggering condition;
determining a second result based on the second phase of benefit decision processing using the first result and a second input value from the plurality of input values;
receiving an indicator of the first input value being changed to an updated input value; and
triggering, in response to the indicator of the change, re-processing of at least a portion of the application based on the first phase of benefit decision processing using the updated input value.

18. The method of claim 17, wherein the first phase of benefit processing and the second phase of benefit processing define at least a portion of an ordered series of phases of the benefit processing.

19. The method of claim 17, wherein satisfying the phase triggering condition is a prerequisite to triggering processing associated with the second phase of the benefit decision processing.

20. The method of claim 17, wherein the application is a first application,
receiving a plurality of input values from a second application for the social benefit; and
terminating processing related to the second application in response to the phase triggering condition being unsatisfied based on an input value from the plurality of input values from the second application.
